(19) United States
(12) Patent Application Publication
(10) Pub. No.: US 2007/0061595 A1
(43) Pub. Date: Mar. 15, 2007

(54) APPARATUS AND METHOD FOR PROTECTING DATA

(76) Inventor: Huang-Chung Chen, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,530

(22) Filed: Sep. 14, 2005

(51) Int. Cl. G06F 12/14

(52) U.S. Cl. 713/193

(57) ABSTRACT

The invention provides an apparatus and a method for protecting data. This apparatus includes a sequential-key comparator and a scrambling device, and a storage device stores encrypted data. When a received address signal is not consistent to a key pattern in the sequential-key comparator, the scrambling device rearranges the address signal and generates a scrambled address signal so that the pirated data are the encrypted data corresponding to the scrambled address signal. As the pirated data become useless, the invention enhances the difficulty of pirating the data, thereby ensuring the data security.

### BACKGROUND OF THE INVENTION

1. Field of the Invention

The present invention generally relates to an apparatus and a method for protecting data, and more particularly, to an apparatus and a method for preventing the data from being pirated or copied.

2. Description of Related Art

In a digital computer system, a storage device for storing data and instructions is required. Referring to FIG. 1, a conventional basic structure for reading the storage device is shown. A microprocessor 100 issues an address signal to a decoder 110 that then decodes the address signal. After that, the decoded address signal is input into the storage device 120, in which the data corresponding to the decoded address signal is selected and then transmitted back to the microprocessor 100. The storage device 120 generally refers to ROM, but the present invention is not limited thereto. In the market, there are many products that implement this conventional basic structure, such as cassette video gamers, a BIOS implemented in a motherboard of a computer or other hardware devices (mobile phones or CD-ROM) that require to load driving programs, all of which need ROMs for storing data or programs. However, if the important data is not protected, it is easily pirated, downloaded and reproduced from the storage device so as to acquire illegal benefit by selling them to others. As such, the intellectual property right of a developer or owner(s) is infringed. Accordingly, the inventor or patent holder's intellectual property can be infringed.

### SUMMARY OF THE INVENTION

Accordingly, the present invention is directed to an apparatus for protecting data, by using a scramble device to scramble its input address signals, and a storage device to store encrypted data, the pirated data would be the encrypted data corresponding to a scrambled address signal. Therefore, even if the data is pirated, the pirated data can not be used, thereby enhancing the difficulty of decrypting the pirated data. In other words, the security of data is more ensured.

The present invention is further directed to a method for protecting data. The method allows the data pirated from a storage device to become encrypted data corresponding to a scrambled address signal. Besides, only under a specific condition that an address signal is consistent to a key pattern, the data can be decrypted and then output, thereby enhancing the data security.

The present invention provides an apparatus for protecting data, including: a scrambling device, a sequential key comparator device, a first multiplexer, a decoder and a storage device. Wherein, the scrambling device receives an address signal, scrambles the address signal and then outputs a scrambled address signal. Moreover, the sequential key comparator device receives the address signal and then determines whether it is consistent to a key pattern. If they are consistent, the sequential key comparator device outputs a first signal, whereas if they are not consistent, a second signal is output. In addition, the first multiplexer receives the address signal and is coupled to the scrambling device and the sequential key comparator device. When receiving the first signal, the first multiplexer outputs the address signal, whereas when receiving the second signal, the first multiplexer outputs the scrambled address signal. The decoder is coupled to the first multiplexer, decodes the address signal output from the first multiplexer and then outputs the decoded address signal. Further, the storage device is coupled to the decoder and supplies data corresponding to the decoded address signal.

The present invention provides a method for protecting data. The method comprises: receiving an address signal; scrambling the address signal and then outputting a scrambled address signal; determining whether a key pattern is consistent to the address signal; if they are consistent, supplying a first data corresponding to the address signal; and if they are not consistent, supplying a second data corresponding to the scrambled address signal.

As the present invention employs the apparatus and the method for protecting data, the scrambled device is capable of rearranging the address signal and then generates the scrambled address signal when the received address signal is not consistent to the key pattern stored in the sequential key comparator device. To further enhance a security functionality of the encrypted data, an encrypted data is further stored in the storage device so that it can output the encrypted data corresponding to the scrambled address signal. Under this mechanism, even if the data is pirated, the data can not be used, thereby making it more difficult to pirate the data and ensuring the data security.

The objectives, other features and advantages of the invention will become more apparent and easily understood from the following detailed description of the invention when taken in conjunction with the accompanying drawings.

### BRIEF DESCRIPTION OF THE DRAWINGS

The accompanying drawings are included to provide further understanding of the invention and are incorporated in and constitute a part of this specification. The drawings illustrate embodiments of the invention and, together with the description, serve to explain the principles of the invention.

FIG. 1 schematically shows a basic structure for reading a conventional storage device.

FIG. 2 shows a circuit block diagram of an apparatus for protecting data according to an embodiment of the present invention.

FIG. 3 shows a circuit block diagram of an apparatus for enhancing protection of data according to an embodiment of the present invention.

FIG. 4 shows a flow chart of a method for protecting data according to an embodiment of the present invention.

FIG. 5 shows a flow chart of a method for enhancing protection of data according to an embodiment of the present invention.

### DESCRIPTION OF THE EMBODIMENTS

Reference will now be made in detail to an apparatus and a method for protecting data, examples of which are illustrated in the accompanying drawings. Wherever possible, the same reference numbers are used in the drawings and the description to refer to the same parts.

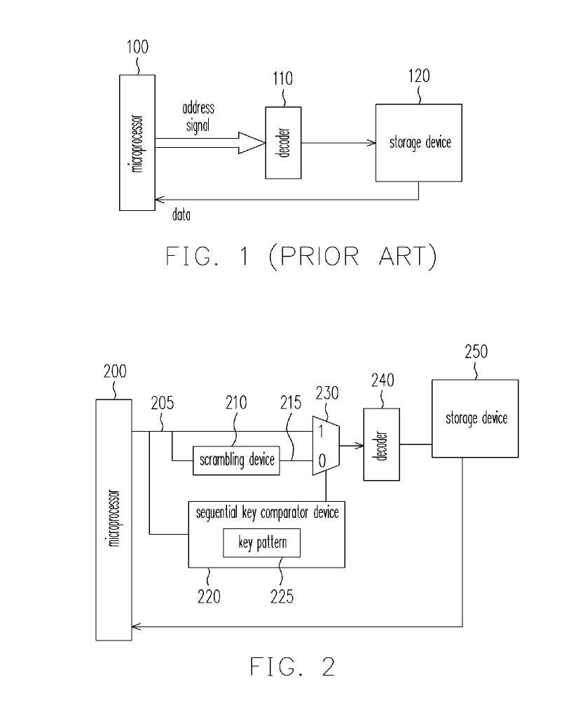

FIG. 2 shows a circuit block diagram of an apparatus for protecting data according to and embodiment of the present invention. Referring to FIG. 2, the apparatus for protecting data comprises: a scrambling device 210, a sequential key comparator device 220, a first multiplexer 230, a decoder 240 and a storage device 250. Wherein, the storage device 250 may not be included in the apparatus for protecting data, depending upon the actual requirement. In this embodiment, the apparatus for protecting data can be regarded as a storage integrated circuit (IC), in which the storage device 250 may be an ROM, an RAM, a flash ROM, or even a hard disk, but not limited to these memory devices.

First of all, a microprocessor 200 generates an address signal 205, which is also a numeral per se in the digital computer system, then transmits it to the scrambling device 210, the sequential key comparator device 220 and the first multiplexer 230. Subsequently, the scrambling device 210 receives the address signal 205 and then generates a scrambled address signal 215. The sequential key comparator device 220 receives the address signal 205 and then determines whether it is consistent to a preset key pattern 225 that is also a numeral per se. Besides, an equality comparator, for example, an exclusive-OR, is capable of determining whether the address signal 205 and the preset key pattern 225 are consistent. If they are consistent, the sequential key comparator device 220 causes the first multiplexer 230 to select and output the address signal 205, whereas if they are not consistent, the sequential key comparator device 220 causes the first multiplexer 230 to select and output the scrambled address signal 215. After that, according to the conventional procedures, the decoder 240 decodes an output address signal from the first multiplexer 230 and then outputs a decoded output address signal to the storage device 250, which in turn selects data in accordance with the decoded output address signal, and then send the data back to the microprocessor 200 or other devices for further processing.

Furthermore, the sequential key comparator device 220 is used to determine whether a section of consecutive sequential address in the input address signal 205 is consistent to a key pattern 225 stored in a storage unit in the sequential key comparator device 220. More, the key pattern 225 of the preferred embodiment of the present invention can be generated according the following method.

The microprocessor 200 executes a certain program, in which the instructions, when executed, would select data in accordance with a specific address sequence, such as, 00000H, 00001H, 00110H, 00111H, etc,. Also, the key pattern 225 is generated by utilizing the first several sets of the specific address sequence. Depending upon actual requirement, different programs or instructions may employ the same or different address sequences. For example, when 5 different sets of programs or instructions are to be executed to access the storage device 250, the consistent address sequence or the number of the consistent address sequence in the 5 different sets of programs or instructions, is used as the key pattern 225. Alternatively, a plurality of different address sequences or the number of the plurality of different address sequences can be used as the key pattern 225. When users intend to pirate the data accessed by the 5 sets of programs or instructions by executing other programs or instructions, he/she is unable to acquire the correct data due to the input address sequence is not consistent to the key pattern 225. The comparison of the key pattern 225 can be a way of comparing the consecutive 32 codes after the sixth code in the address signal 205, and depending upon a designer's consideration, one of ordinary skill in the art may apply this comparison method to analogize other comparison methods of other key patterns 225.

Additionally, the scrambling device 210 scrambles the received address signal and then outputs a scrambled address signal that is not consistent to the original address signal. In addition, the scrambling method may comprise, for example, translating, encoding, inserting, breaking up, recombining, and random-generating the address signal or may direct it to useless data. One of ordinary skill in the art may design the scrambling device 210 by oneself so that when reading the data, the original address sequence for reading the data is scrambled and the storage device 250 outputs data corresponding to the scrambled address signal 215.

When the apparatus for protecting data is applied to the cassette video gamer, to avoid from being decrypted, a comparison with the key pattern 225 is required in each checking-gate set up between the scrambling device 210 and the sequential key comparator device 220. Meanwhile, when this comparison shows that an input address signal is not consistent to the key pattern 225, the first multiplexer 230 is switched to be coupled to the scrambling device 210, which disables the pirate to execute a next checking-gate.

To further enhance protection of data, encrypted data is further stored in the storage device 250, and under a specific condition that the sequential key comparator device 220 finds the address signal 205 and the key pattern 225 are consistent, the encrypted data is decrypted and then output.

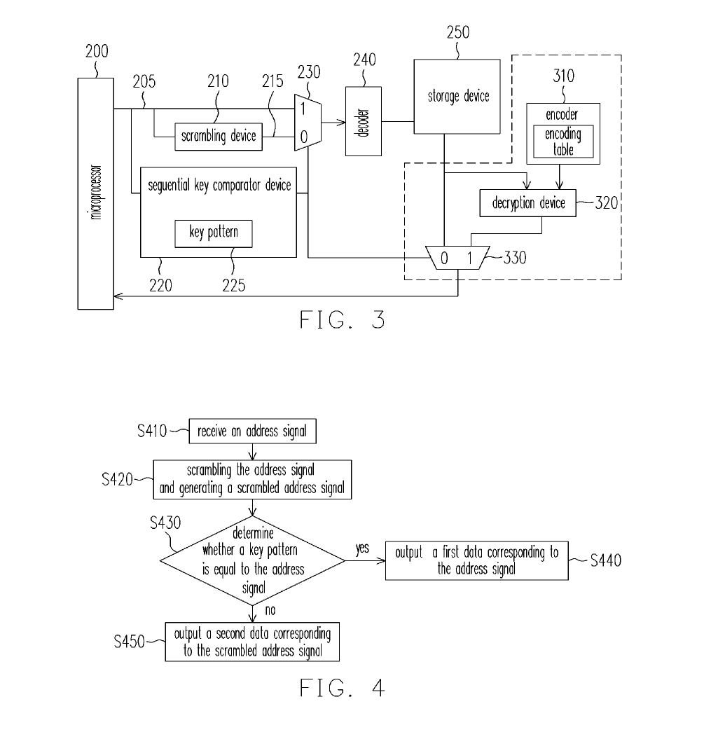

FIG. 3 shows a circuit block diagram of an apparatus for enhancing protection of data according to an embodiment of the present invention. When the circuit block diagram shown in the FIG. 2 is compared with that shown in FIG. 3, FIG. 3 has an extra added device shown by a dashed line. The added device can enhance the security of the data, and comprises an encoder 310, a decryption device 320 and a second multiplexer 330. More, the encrypted data is stored in the storage device 250. In addition, the encoder 310 comprises an encoding table, according to which data to be stored is encoded, and then stored in the storage device 250 so as to make the data become the encrypted data. Furthermore, the decryption device 320 is coupled to the storage device 250 and the encoder 310, decodes the data output from the storage device 250 in accordance with the encoding table and outputs the decoded original data. The second multiplexer 330 is coupled to the sequential key comparator device 220, the decryption device 320 and the storage device 250, outputs the decoded original data when the key pattern 225 is consistent to the address signal 205. However, when the key pattern 225 is not consistent to the address signal 205, the storage device 250 outputs the encrypted data corresponding to the scrambled address signal 215 and the encrypted data is directly output through the second multiplexer 330 without the aforementioned decryption procedure.

In this embodiment, the decryption device 320 operates as an exclusive-OR(XOR) for an output from the storage device and the encoding table, which determines whether the output from the storage device 250 is consistent to the encoding table included in the encoder 310, and then generates the decrypted data. One of ordinary skill in the art is able to design another decryption device for further encrypting data by oneself, but the present invention is not limited to the preceding decryption device.

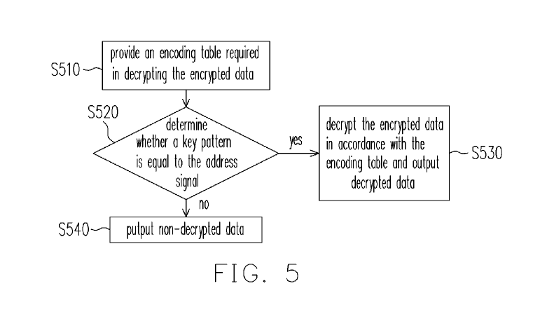

Referring to FIG. 4, it shows a flow chart of protecting data according to an embodiment of the present invention. The method comprises the following steps. First, the scrambling device 210, the sequential key comparator device 220 and the first multiplexer 230, receive the address signal 205 (step S410). After that, the scrambling device 210 scrambles the address signal 205 and generates the scrambled address signal 215 (step S420), then the sequential key comparator device 220 compares the key pattern 225 with the address signal 205 (step S430). If the address signal 205 is determined to be consistent to the key pattern 225, the first multiplexer 230 outputs the address signal 205, which is in turn decoded by the decoder 240. Then, the decoded address signal causes the storage device 250 to output a first data corresponding to the address signal 205 (step S440). However, if the address signal 205 is determined to be not consistent to the key pattern 225, the first multiplexer 230 outputs the scrambled address signal 215, which is in turn decoded by the decoder 240 to be a decoded scrambled address signal. Then, the storage device 250 outputs a second data corresponding to the scrambled address signal 215, in response to the decoded scrambled address signal (step S450).

To further enhance protection of data, in this embodiment, before storing the data into the storage device 250, the data is encrypted in accordance with the encoding table so that the data stored in the storage device 250 is an encrypted data. Accordingly, the functionality of enhancing the protection of data can be achieved by the following steps.

Referring to FIG. 5, it shows a flow chart of enhancing protection of data according to an embodiment of the present invention. The flow chart shown in FIG. 5 follows the step S440 or the step S450 shown in FIG. 4. When the storage device 250 supplies the encrypted data, the steps are as follows: First, the encoder 310 supplies the encoding table required for decrypting the encrypted data (step S510). Then, the sequential key comparator device 220 determines whether the key pattern 225 and the address signal 205 are consistent (step S520). If they are consistent (According to the preceding paragraph, the encrypted data output from the storage device 250 is the first data), the decoder 320 decrypts the encrypted data (i.e. the first data) supplied by the storage device 250 in accordance with the encoding table, and then generates as well as outputs decrypted data to the second multiplexer 330 that in turn outputs the decrypted data (step S530). However, if they are not consistent (According the preceding paragraph, the encrypted data output from the storage device 250 is the second data), the second data supplied by the storage device 250 is directly output, without the decryption process of the decoder 320, to the second multiplexer 330 that in turn outputs undecrypted data (step S540).

In summary, in the apparatus and the method for protecting data of the present invention, the dada can be secured only by adding a few circuits to the storage IC (such as flash or ROM) implemented in a hardware structure. Therefore, if the received address signal 205 is not consistent to the key pattern 225 stored in the sequential key comparator device 220, the scrambled device 210 is capable of rearranging the address signal 205 and then generates the scrambled address signal 215. To further enhance a security functionality of the encrypted data, an encrypted data is further stored in the storage device 250 so that it can output the encrypted data corresponding to the scrambled address signal 215. Accordingly, even if the data is pirated, the pirated data cannot be used, thereby making it more difficult to pirate the data and promoting the data security.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for protecting data, suitable for protecting the data stored in a storage device; the apparatus comprising:
a scrambling device, receiving an address signal, for scrambling the address signal and outputting a scrambled address signal;
a sequential key comparator device, receiving the address signal and determining whether a key pattern is consistent to the address signal, wherein the sequential key comparator device outputs a first signal if the key pattern and the address signal are consistent, or outputs a second signal if the key pattern and the address signal are not consistent;
a first multiplexer, coupled to the scrambling device and the sequential key comparator device, and receiving the address signal, wherein the first multiplexer outputs the address signal when receiving the first signal, and outputs the scrambled address signal when receiving the second signal; and
a decoder, coupled to the first multiplexer and the storage device, decoding an output of the first multiplexer and then outputting a decoded address signal to the storage device that in turn data corresponding to the decoded address signal are output.

2. The apparatus for protecting data according to claim 1, wherein the data stored in the storage device are encrypted data.

3. The apparatus for protecting data according to claim 2, further comprising:
an encoder, comprising an encoding table, for encoding data to be stored to the encrypted data in accordance with the encoding table before data are stored into the storage device;
a decryption device, coupled to the storage device and the encoder, for decrypting data output from the storage device to the decrypted data in accordance with the encoding table; and
a second multiplexer, coupled to the sequential key comparator device, the decryption device and the storage device, wherein the second multiplexer outputs the decrypted data when receiving the first signal, and outputs data supplied by the storage device when receiving the second signal.

4. The apparatus for protecting data according to claim 3, wherein the decryption device executes an exclusive-OR operation for the data supplied by the storage device and the encoding table, thereby generating the decrypted data.

5. The apparatus for protecting data according to claim 1, wherein the sequential key comparator device comprises a storage unit for storing the key pattern.

6. The apparatus for protecting data according to claim 1, wherein the method for the scrambling device to scramble the address signal comprises translating, encoding, inserting, breaking up, recombining, and random-generating the address signal or directing the address signal to useless data.

7. The apparatus for protecting data according to claim 1, wherein the storage device is an ROM.

8. The apparatus for protecting data according to claim 1, wherein the storage device is an RAM.

9. The apparatus for protecting data according to claim 1, wherein the storage device is a flash ROM.

10. A method for protecting data, comprising:
receiving an address signal;
scrambling the address signal and generating a scrambled address signal;
determining whether a key pattern is consistent to the address signal;
outputting a first data corresponding to the address signal if the key pattern is consistent to the address signal;
outputting a second data corresponding to the scrambled address signal if the key pattern is not consistent to the address signal.

11. The method for protecting data according to claim 10, wherein the first data and the second data are encrypted data.

12. The method for protecting data according to claim 11, wherein when the first data and the second data are encrypted data; the method further comprising:
providing an encoding table for decrypting the encrypted data;
decrypting the first data in accordance with the encoding table and outputting the decrypted first data if the key pattern is consistent to the address signal; and
outputting the encrypted second data without decrypting if the key pattern is not consistent to the address signal.
